(19) United States
(12) Patent Application Publication
(10) Pub. No.: US 2010/0102620 A1
(43) Pub. Date: Apr. 29, 2010

(54) METHOD FOR PREVENTING DIRTYING OF VEHICLE WHEEL AND VEHICLE WHEEL

(75) Inventors: Takahisa Sudo, Toyota-shi (JP); Kazuyuki Kuwano, Toyota-shi (JP); Keiji Koike, Toyota-shi (JP); Masayuki Iwasaki, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignees: TOYOTA JIDOSHA KABUSHIKI KAISHA, Toyota-shi, Aichi (JP); CENTRAL MOTOR WHEEL CO., LTD., Anjo-shi, Aichi (JP)

(21) Appl. No.: 12/524,684

(22) PCT Filed: Dec. 14, 2007
(86) PCT No.: PCT/JP2007/074591

§ 371 Date: Jul. 27, 2009

(30) Foreign Application Priority Data
Jan. 30, 2007 (JP) 2007-019218

(51) Int. Cl. B60B 19/00; B05D 1/38

(52) U.S. Cl. 301/5.1; 427/419.2

(57) ABSTRACT

An object of the present invention is to obtain a vehicle wheel having a significant effect of preventing dirtying due to brake dust. A + (positively)-charged coating film in which the water contact angle is 35° or less and the product of saturated charging voltage (kV)×charge half life (sec) is 50 or less is formed on the surface of a vehicle wheel.

### TECHNICAL FIELD

The present invention relates to a method for preventing dirtying of vehicle wheels and vehicle wheels treated for preventing dirtying.

### BACKGROUND ART

Many means for preventing dirtying of products' surfaces have been conventionally proposed. For example, Patent document 1 (JP Patent Publication (Kokai) No. 10-237358 A (1998)) proposes an inorganic paint containing a silicone resin as a major component and an optical semiconductor therein and being capable of maintaining its antistatic function for a long time period. Patent document 2 (JP Patent Publication (Kokai) No. 2002-003820 A) discloses an antifouling agent for hard surfaces, which is capable of suppressing adhesion of dirt to hard surfaces such as vehicle bodies or glass and contains a positively charged silica-based compound having a mean particle diameter ranging from 1 nm to 100 nm and water. Patent document 3 (JP Patent Publication (Kokai) No. 2005-298944) discloses a glass coating method appropriate for two-wheel vehicles, by which hydrophilic glass coating can remove the burden of maintenance.

### DISCLOSURE OF THE INVENTION

Vehicles provided with levels of high brake performance that have been marketed recently are problematic in that dust coming from brake pads adheres to vehicle wheels so as to make the wheels dirty. Measures against such problem are currently required. The present inventors have attempted to obtain the effect of preventing such dirtying by providing various above-described conventionally known means to prevent dirtying of vehicle wheels. However, the present inventors have failed to obtain sufficient effect of preventing dirtying via brake dust.

The present invention has been completed to cope with the above circumstances. An object of the present invention is to provide an improved method for preventing dirtying of vehicle wheels, which realizes low degrees of dirtying via brake dust and excellent washing efficiency. Another object of the present invention is to provide vehicle wheels treated for preventing dirtying.

### Means for Achieving the Objects

To achieve the above objects, the present inventors have collected and analyzed brake dust, and they have thus revealed that brake dust is composed of fine powders of brake pads in most cases, that inorganic oxide surfaces are covered with an oil content (organic matter) in most cases, and that brake dust is positively charged (+ (plus)-charged) in most cases.

The present invention is based on the above understanding. The method for preventing dirtying of a vehicle wheel according to the present invention comprises forming on the surface of the vehicle wheel a + (positively)-charged coating film in which the water contact angle is 35° or less and the product of saturated charging voltage (kV)×charge half life (sec) is 50 or less.

Furthermore, the vehicle wheel according to the present invention is a vehicle wheel wherein a + (positively)-charged coating film in which the water contact angle is 35° or less and the product of saturated charging voltage (kV)×charge half life (sec) is 50 or less is formed on the surface of the wheel.

As described later in Examples, the vehicle wheel according to the present invention has a coating film formed thereon. The surface of the coating film is hydrophilic (its water contact angle is 35° or less and preferably 10° or less) so that the adhesion of brake dust covered with oil is weak and thus the same is easily removable. In addition, the water contact angle of the brake dust was almost 62° and the oil contact angle was almost 6°. Furthermore, in addition to hydrophilicity, the wheel surface is + (positively)-charged. Thus, the wheel surface and + (positively)-charged brake dust are electrostatically repelled from each other, preventing brake dust from adhering to the wheel. Moreover, the wheel surface has a low charge such that the product of saturated charging voltage (kV)×charge half life (sec) is 50 or less (preferably 20 or less). Hence, the wheel surface is grounded immediately after the vehicle is brought to a stop, so that it does not attract any excessive dust.

With a combination of these effects, the vehicle wheel according to the present invention can exert a significant effect of preventing dirtying via brake dust. The film thickness to be formed on the wheel surface is not limited. A desired purpose can be sufficiently achieved with a film thickness ranging from approximately 0.1 μm to 0.25 μm. With the film thickness is less than 0.1 μm, however, sufficient performance for preventing dirtying may not be obtained. Film thickness of more than 0.25 μm would be excessive.

In the present invention, the surface of a vehicle wheel refers to the surface of the wheel's base material itself, an alumite surface formed on the surface of a base material that is aluminum, or the surface of a coating film when the coating film to be formed on the surface of a base material comprises conventionally known acrylic melamine or the like (e.g., Acrylic clear), for example.

The vehicle wheel according to the present invention may be a vehicle wheel with a coating film having the above-described properties on its surface. Materials to be used for such coating film are not particularly limited, as long as the above conditions are satisfied. According to the experiments conducted by the present inventors, one preferable example of such material is an inorganic material containing amorphous-type titanium oxide as a major component and a hydrophilic group. Such inorganic material may be mixed with a conducting metal such as tin, copper, nickel, cobalt, iron, zinc, manganese, or a compound thereof, so as to improve electrification characteristics. A specific example of the same is titanium oxide containing a peroxo group.

Another example of such material is an inorganic material containing oxide silicon as a main backbone and a hydrophilic group. Specific examples of such inorganic material include (a) an inorganic material, which contains —Si—O—Si—O— (siloxane bond) as a backbone and an OH group; (b) a material made of an organic material bound to an inorganic material that has an organic portion such as CH₃ and an inorganic portion containing —Si—O—Si—O— as a backbone (however, the organic portion is not limited to a methyl group) and contains an OH-group; and (c) an inorganic material, which contains an organic portion comprising titanium alkoxide in a —Ti—O—Si—O— portion as a backbone, and an OH-group; and (d) a mixture of (b) and (c) above.

### EXAMPLES

The present invention will now be described with reference to Examples and Comparative examples.

### Example 1

Aluminum (alumite) having alumite was used as a base material for vehicle wheels. The surface was spray-coated with an inorganic coating agent containing amorphous-type titanium oxide (TiO₂) as a major component, at least one of copper, manganese, nickel, cobalt, iron, zinc, and a compound thereof coexisting therewith as a conducting metal, and a hydrophilic group (OH group). After spray-coating, dry treatment was performed. An inorganic coating film with a film thickness of 0.1 μm was formed on the surface of the base material, thereby resulting in a material for evaluation.

### Example 2

A base material having an acrylic coating film formed on an aluminum surface was used as a base material for vehicle wheels. The acrylic coating film surface was spray-coated with polysiloxane that contained a hydroxyl group localized on the surface and was an inorganic coating agent containing oxide silicon (SiO) as a main backbone and a hydrophilic group (OH group). After spray coating, dry treatment was performed. An inorganic coating film with a film thickness of 0.2 μm was formed on the acrylic coating film surface, thereby resulting in a material for evaluation.

### Comparative Example 1

The surface of the base material used in Example 1 was spray-coated with an inorganic coating agent containing amorphous-type titanium oxide (TiO₂) as a major component, at least one of copper, manganese, nickel, cobalt, iron, zinc, and a compound thereof coexisting therewith as a conducting metal, and a water-repellent group. After spray coating, dry treatment was performed. An inorganic coating film with a film thickness of 0.1 μm was formed on the surface of the base material, thereby resulting in a material for evaluation.

### Comparative Example 2

The acrylic coating film surface of the base material used in Example 2 was spray-coated with an inorganic coating agent containing oxide silicon (SiO) as a main backbone and a water-repellent group. After spray coating, dry treatment was performed. An inorganic coating film with a film thickness of 0.2 μm was formed on the acrylic coating film surface, thereby resulting in a material for evaluation.

### Comparative Example 3

A coating film comprising polysilazane containing —SiH₂NH— as the main backbone was formed on the acrylic coating film surface of the base material used in Example 2. The base material was baked and dried at 120° C. so as to form a polysilazane inorganic film with a thickness of 0.5 μm, thereby resulting in a material for evaluation.

### Comparative Example 4

An acrylic melamine resin (known as Acrylic clear) coating film was formed on the aluminum surface used in Example 2, thereby resulting in a material for evaluation.

### Comparative Example 5

The aluminum used in Example 2 was directly used as a base material for evaluation.

### Comparative Example 6

A 6,6 nylon membrane was used as a base material for evaluation.

### Comparative Example 7

A PTFE (polytetrafluoroethylene) film was used as a base material for evaluation.

### Comparative Example 8

A chrome plated face formed on an aluminum plate was used as a base material for evaluation.

### Comparative Example 9

Glass was used as a base material for evaluation.

### [Evaluation 1]

Water contact angle: Water contact angle)(°) was measured for the base materials for evaluation of Examples 1 and 2 and the base materials for evaluation of Comparative examples 1 to 9. Table 1 shows the results.

### [Evaluation 2]

Saturated charging voltage (kV)×charge half life (sec): Saturated charging voltage (kV)×charge half life (sec) was obtained via measurement performed for the base materials for evaluation of Examples 1 and 2 and the base materials for evaluation of Comparative examples 1 to 9. This was performed by obtaining a test specimen (50 mm×50 mm) from each base material for evaluation, applying +10 kV via corona discharge without contact, obtaining a value when the charging voltage of the relevant test specimen had reached saturation as “saturated charging voltage (kV),” stopping application voltage to the test specimen, and then obtaining the time required for the saturated charging voltage that had decreased by half as the “charge half life (sec).” For measurement, an apparatus for measuring the attenuance of electrification charge (produced by SHISHIDO ELECTROSTATIC, LTD., STATIC HONESTMETER H-0110) was used. Table 1 shows the results.

### [Evaluation 3]

Charging polarity: Charging polarity was measured using an electrostatic voltmeter (produced by SHISHIDO ELECTROSTATIC, LTD., STATIRON DZ3) for the base materials for evaluation of Examples 1 and 2 and the base materials for evaluation of Comparative examples 1 to 9, which were all in a state of being charged. Table 1 shows the results, wherein “+” indicates polarity of +5V or higher and “−” indicates polarity of −5V or less.

### [Evaluation 4]

Measurement of degree of dirtying: A dirtying test was conducted using a brake-dust dirtying testing machine for the base materials for evaluation of Examples 1 and 2 and the base materials for evaluation of Comparative examples 1 to 9. Dirtying tested herein corresponded to dirtying resulting from actual vehicle mileage of 4000 km. Standard surfaces before dirtying and surfaces after dirtying were subjected to measurement using a colorimeter (produced by Konica Minolta Holdings, Inc., CR-300). Color difference ΔE was designated as representing the degree of dirtying. Table 1 shows the results.

### [Evaluation 5]

Measurement of efficiency of washing: A dirtying test was conducted using the brake-dust dirtying testing machine for the base materials for evaluation of Examples 1 and 2 and the base materials for evaluation in Comparative examples 1 to 9. Dirtying tested herein corresponded to dirtying resulting from actual vehicle mileage of 4000 km. Subsequently, each dirty surface was washed with running water for 5 seconds while keeping its face 20 cm away from the tap (from which water flowed at 6 liters per minute). Standard surfaces before washing and surfaces after dirtying were subjected to measurement using a colorimeter (produced by Konica Minolta Holdings, Inc., CR-300). Color difference ΔE was designated as representing efficiency of washing. Table 1 shows the results.

TABLE 1

| | | Saturated | | | |
|---|---|---|---|---|---|
| | Water | charging | Charg- | | Efficiency |
| | contact | voltage (kV) × | ing | Degree of | of |
| Materials for | angle | charge half | polar- | dirtying | washing |
| evaluation | (°) | life (s) | ity | (ΔE) | (ΔE) |
| Example 1 | 32 | 0 (0 kV × | + | 1.3 | 1.1 |
| | | 0 s) | | | |
| Example 2 | 7 | 16 (2.05 kV × | + | 2.7 | 0.5 |
| | | 7.8 s) | | | |
| Comparative | 104 | 0 (0 kV × | + | 68.7 | 24.6 |
| example 1 | | 0 s) | | | |
| Comparative | 99 | 11406 (2.72 | − | 61.4 | 21.9 |
| example 2 | | kV × | | | |
| | | 4193.4 s) | | | |
| Comparative | 29 | 58 (2.44 kV × | − | 49.7 | 2.6 |
| example 3 | | 023.9 s) | | | |
| Comparative | 84 | 13815 (2.73 | − | 84.3 | 37.0 |
| example 4 | | kV × | | | |
| | | 5060.4 s) | | | |
| Comparative | 101 | 0 (0 kV × | − | 34.9 | 12.5 |
| example 5 | | 0 s) | | | |
| Comparative | 74 | 209 (2.94 | + | 36.0 | 17.7 |
| example 6 | | kV × 71.2 s) | | | |
| Comparative | 105 | 13474 (2.98 | − | 40.4 | 15.8 |
| example 7 | | kV × | | | |
| | | 4521.6 s) | | | |
| Comparative | 75 | 0 (0 kV × | − | 44.3 | 11.8 |
| example 8 | | 0 s) | | | |
| Comparative | 49 | 25 (2.62 kV × | − | 64.6 | 5.0 |
| example 9 | | 9.6 s) | | | |

### [Evaluation 6]

Based on past experience, when both the degree of dirtying (ΔE value) measured under the conditions explained in Evaluation 4 above and the efficiency of washing (ΔE value) measured under the conditions explained in Evaluation 5 above were approximately 10 or less, the state of the relevant vehicle wheel was determined to be “clean.” Accordingly, the materials of Example 1 and Example 2 achieved the desired purpose of the present invention. It was demonstrated based on comparison between the materials of Examples 1 and 2 and the materials of the Comparative examples that the desired purpose was achieved by forming a coating film that satisfied conditions regarding characteristic values, including a water contact angle of 35° or less, saturated charging voltage (kV)×charge half life (sec)=50 or less, and charging polarity of + on the surface of a vehicle wheel.

Table 2 is another version of Table 1, in which a material satisfying each parameter of the above conditions is marked with “o,” but a material not satisfying the same is marked with “x.” However, “degree of dirtying” and “efficiency of washing” are collectively referred to as “degree of dirtying” regarding which each material is evaluated as “clean” or “dirty.”

TABLE 2

| | | Saturated | | |
|---|---|---|---|---|
| | | charging | | |
| | | voltage (kV) × | | |
| Materials for | Water contact | charge half life | Charging | Degree of |
| evaluation | angle (°) | (s) | polarity | dirtying |
| Example 1 | ∘ | ∘ | ∘ | Clean |
| Example 2 | ∘ | ∘ | ∘ | Clean |
| Comparative | x | ∘ | ∘ | Dirty |
| example 1 | | | | |
| Comparative | x | x | x | Dirty |
| example 2 | | | | |
| Comparative | ∘ | x | x | Dirty |
| example 3 | | | | |
| Comparative | x | x | x | Dirty |
| example 4 | | | | |
| Comparative | x | ∘ | x | Dirty |
| example 5 | | | | |
| Comparative | x | x | ∘ | Dirty |
| example 6 | | | | |
| Comparative | x | x | x | Dirty |
| example 7 | | | | |
| Comparative | x | ∘ | x | Dirty |
| example 8 | | | | |
| Comparative | x | x | x | Dirty |
| example 9 | | | | |

It was understood from Tables 1 and 2 and as shown in the case of Comparative example 4 that an acrylic melamine coating film that has been conventionally used was insufficient for prevention of adhesion of brake dust. Furthermore, as shown in the cases of Comparative examples 1 and 2, it was also understood that a coating film provided with a water-repellent group was insufficient for prevention of adhesion of brake dust, even when the film comprised an inorganic material containing amorphous-type titanium oxide as a major component or an inorganic material containing oxide silicon as a main backbone. In the case of polysilazane in Comparative example 3, the water contact angle satisfied the conditions; however, the product of saturated charging voltage (kV)×charge half life (sec) was as high as 58 and the charging polarity was “−.” Thus, such material of Comparative example 3 was also insufficient for prevention of adhesion of brake dust.

The surfaces of the materials of Comparative examples 5 to 9 were each subjected to measurement and comparison. It was understood that the materials of Comparative examples 5 to 9 were inferior to the material of Example 1 or 2 in terms of adherence of brake dust and efficiency of washing, except for cases in which a coating film comprising the material described in Example 1 or 2 was formed on the surface.

### INDUSTRIAL APPLICABILITY

The present invention can be efficiently used in the field of vehicle wheels, where brake-dust dirtying should be avoided.

1. A method for preventing dirtying of a vehicle wheel, which comprises forming on the surface of a vehicle wheel a + (positively) charged coating film in which the water contact angle is 35° or less and the product of saturated charging voltage (kV)×charge half life (sec) is 50 or less.

2. The method for preventing dirtying of a vehicle wheel according to claim 1, wherein the material to be used for the coating film is an inorganic material containing amorphous-type titanium oxide as a major component, a hydrophilic group, and, preferably, a conducting metal.

3. The method for preventing dirtying of a vehicle wheel according to claim 1, wherein the material to be used for the coating film is an inorganic material containing oxide silicon as a main backbone and a hydrophilic group.

4. A vehicle wheel, wherein a + (positively charged) coating film in which the water contact angle is 35° or less and the product of saturated charging voltage (kV)×charge half life (sec) is 50 or less is formed on the surface of the vehicle wheel.

5. The vehicle wheel according to claim 4, wherein the coating film comprises an inorganic material containing amorphous-type titanium oxide as a major component, a hydrophilic group, and, preferably, a conducting metal.

6. The vehicle wheel according to claim 4, wherein the coating film comprises an inorganic material containing oxide silicon as a main backbone and a hydrophilic group.
